(19) United States
(12) Patent Application Publication
(10) Pub. No.: US 2022/0295186 A1
(43) Pub. Date: Sep. 15, 2022

(54) SHOULDER-MOUNTED SPEAKER

(71) Applicant: Yamaha Corporation, Hamamatsu (JP)

(72) Inventor: Miyu MIYAZAKI, Hamamatsu (JP)

(21) Appl. No.: 17/694,359

(22) Filed: Mar. 14, 2022

(30) Foreign Application Priority Data
Mar. 15, 2021 (JP) 2021-41145

(51) Int. Cl. H04R 5/02; H04R 3/14; H04R 1/28; H04R 5/04

(52) U.S. Cl. CPC H04R 5/02; H04R 3/14; H04R 1/2811; H04R 5/04

(57) ABSTRACT

A shoulder-mounted speaker comprises a processor configured to acquire a first signal and a second signal that is a sound signal, a vibrator configured to vibrate based on the first signal input from the processor, and a speaker configured to emit sound based on the second signal input from the processor.

### CROSS-REFERENCE TO RELATED APPLICATIONS

This application claims priority to Japanese Patent Application No. 2021-41145 filed in Japan on Mar. 15, 2021. The entire disclosure of Japanese Patent Application No. 2021-41145 is hereby incorporated herein by reference.

### BACKGROUND

### Field of the Invention

This invention relates to a shoulder-mounted speaker that is used while placed on the shoulders of a user.

### Background Information

In a wearable speaker of Japanese Laid-Open Patent Application No. 2018-174581 (Patent Literature 1), a first speaker unit and a second speaker unit each have a speaker and a passive radiator. With this configuration, in the wearable speaker, a space is formed between the speaker and the passive radiator. In this case, fluctuation of the air pressure inside each speaker unit is transmitted to this space the air inside the space vibrates). That is, the wearable speaker of Patent Literature 1 vibrates based on sound emitted from the speaker. These vibrations emphasize low-frequency sound. As a result, it is possible to give the wearer or user of the wearable speaker a sense of presence.

### SUMMARY

Moreover, in the wearable speaker of Patent Literature 1, it is desired that the wearable speaker be configured in such a way that with the user can readily recognize the rhythm of the reproduced sound while recognizing surrounding sounds.

In the case of the wearable speaker of Patent Literature 1, the low-frequency sound can be further emphasized by increasing the volume level of the speaker. In this case, the user can recognize the rhythm of the sound based on the emphasized low-frequency sound. However, if the low-frequency sound is further emphasized, the user may not be able to recognize the sounds surrounding the user.

An object is to provide a shoulder-mounted speaker with which the user can readily recognize the rhythm of the reproduced sound while recognizing surrounding sounds.

In view of the state of the known technology, a shoulder-mounted speaker is provided that comprises a processor that acquires a first signal and a second signal, which is a sound signal, a vibrator that vibrates based on the first signal input from the processor, and a speaker that emits sound based on the second signal input from the processor.

By means of the shoulder-mounted speaker, the user can readily recognize the rhythm of the reproduced sound while recognizing surrounding sounds.

### BRIEF DESCRIPTION OF THE DRAWINGS

Referring now to the attached drawings which form a part of this original disclosure:

FIG. 1 is a block diagram illustrating the configuration of a shoulder-mounted speaker 10 according to a first embodiment.

FIG. 2A is a flowchart showing the processing sequence of a first signal SL1 in the shoulder-mounted speaker 10 according to the first embodiment.

FIG. 2B is a flowchart showing the processing sequence of a second signal SL2 in the shoulder-mounted speaker 10 according to the first embodiment.

FIG. 3 is a block diagram illustrating one example of the connection between the shoulder-mounted speaker 10 and an external device ExD.

FIG. 4A is a top view showing the appearance of the shoulder-mounted speaker 10 according to the first embodiment.

FIG. 4B is a left side view showing the appearance of the shoulder-mounted speaker 10 according to the first embodiment.

FIG. 5A is a top view showing the appearance of a shoulder-mounted speaker 10a according to a second embodiment.

FIG. 5B is a left side view showing the appearance of the shoulder-mounted speaker 10a according to the second embodiment.

FIG. 6A is a block diagram illustrating the configuration of a shoulder-mounted speaker 10b according to a third embodiment.

FIG. 6B is a block diagram illustrating the configuration of a shoulder-mounted speaker 10b2 according to the third embodiment.

FIG. 7A is a block diagram illustrating the configuration of a shoulder-mounted speaker 10d according to a fourth embodiment.

FIG. 7B is a block diagram illustrating the configuration of a shoulder-mounted speaker 10d2 according to the fourth embodiment.

FIG. 8 is a block diagram illustrating the configuration of a shoulder-mounted speaker 10e according to a fifth embodiment.

FIG. 9 is a block diagram illustrating the configuration of a shoulder-mounted speaker 10f according to a sixth embodiment.

FIG. 10A is a graph showing one example of changes in the first signal SL1 and the second signal SL2 in a shoulder-mounted speaker 10g according to a seventh embodiment.

FIG. 10B is a graph showing one example, which is unlike the one shown in FIG. 10A, of changes in the first signal SL1 and the second signal SL2 in the shoulder-mounted speaker 10g according to the seventh embodiment.

FIG. 11 is a block diagram illustrating a configuration of a shoulder-mounted speaker 10h according to an eighth embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### First Embodiment

### Configuration of Shoulder-Mounted Speaker

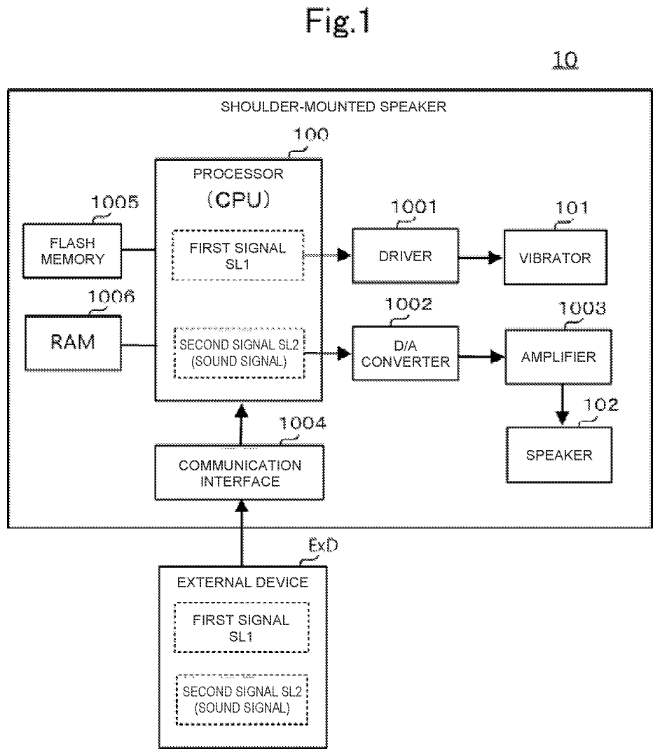

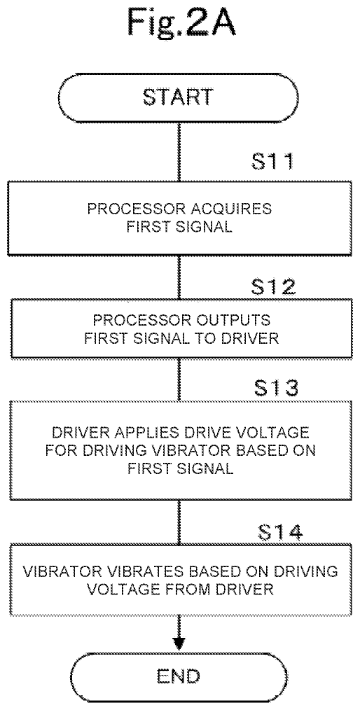

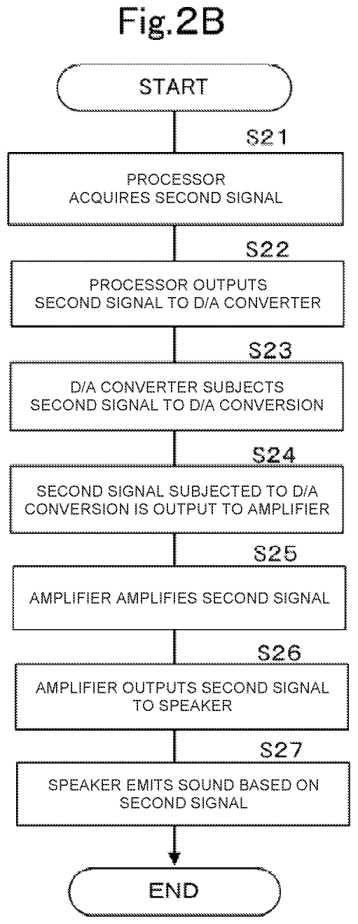

A configuration of a shoulder-mounted speaker 10 according to a first embodiment will be described below with reference to the drawings. FIG. 1 is a block diagram illustrating the configuration of the shoulder-mounted speaker 10 according to the first embodiment. FIG. 2A is a flowchart showing the processing sequence of a first signal SL1 in the shoulder-mounted speaker 10 according to the first embodiment. FIG. 2B is a flowchart showing the processing sequence of a second signal SL2 in the shoulder-mounted speaker 10 according to the first embodiment.

As shown in FIG. 1, the shoulder-mounted speaker 10 comprises a processor (processing unit) 100, a vibrator 101, a speaker 102, a driver (drive unit) 1001, a D/A (digital-to-analog) converter 1002, an amplifier 1003, a communication interface 1004, flash memory 1005, and RAM 1006.

As shown in FIG. 1, the communication interface 1004 communicates via a signal line with an external device ExD, which is a device different from the shoulder-mounted speaker 10. External device ExD generates the first signal SL1 and the second signal SL2, and outputs the first signal SL1 and the second signal SL2. The shoulder-mounted speaker 10 and the external device ExD communicates with each other by wire or wirelessly, such as via Wi-Fi (registered trademark), Bluetooth (registered trademark), or the like. Specifically, the communication interface 1004 is a hardware device capable of receiving the first signal SL1 and the second signal SL2. When the shoulder-mounted speaker 10 and the external device ExD are connected to each other by wire (via the signal line shown in FIG. 1), the communication interface 1004 is, for example, a USB (Universal Serial Bus), an HDMI (registered trademark) (High Definition Multimedia Interface), or the like. The shoulder-mounted speaker 10 and the external device ExD can be connected by an interface such as an audio interface, a MIDI interface, or the like. In this case, the audio interface sends and receives sound signals, and the MIDI interface sends and receives control signals. Also, the communication interface 1004 can be a wireless communicator. The term “wireless communicator” as used herein can include a receiver, a transmitter, a transceiver, a transmitter-receiver, and contemplates any device or devices, separate or combined, capable of transmitting and/or receiving wireless communication signals including the first signal SL1 and the second signal SL2. However, the communication interface 1004 can be a one-way communication device such as a receiver if the audio signal only needs to be wirelessly inputted from the external device ExD. Of course, the communication interface 1004 can include a plurality of communication interfaces for different connection or communication standards.

The flash memory 1005 stores various types of data. Various types of data include, for example, programs for realizing the function of the processor 100.

The RAM 1006 temporarily stores prescribed data stored in the flash memory 1005. As a result, the processor 100 reads a program stored in the flash memory 1005 into the RAM 1006 and thereby carries out various operations. The program can be stored in another device (such as an external server).

The processor 100 processes signals (signal acquisition, signal output, etc.) in the shoulder-mounted speaker 10. Specifically, as shown in FIG. 1, the processor 100 acquires the first signal SL1 and the second signal SL2 from the external device ExD via the communication interface 1004. As shown in FIG. 1, the first signal SL1 and the second signal SL2 are different signals. Specifically, the second signal SL2 is a sound signal. A sound signal is, specifically, a digital signal obtained by sampling sound at a prescribed sampling rate. The first signal SL1, on the other hand, is not a sound signal. Specifically, the first signal SL1 is a control signal for controlling a motor, or the like. After the first signal SL1 and the second signal SL2 are input, the processor 100 outputs the first signal SL1 to the vibrator 101 via the driver 1001. The processor 100 also outputs the second signal SL2 to the speaker 102 via the D/A converter 1002 and the amplifier 1003. In particular, the processor 100 outputs the first signal SL1 to the vibrator 101 to generate a vibration, while the processor 100 outputs the second signal SL2 to the speaker 102 to output sound. In the illustrated embodiment, the processor 100 is a hardware device capable of executing a software program, and does not include a human. In the illustrated embodiment, the processor 100 includes a CPU. However, in some cases, the processor 100 can be configured to comprise, instead of the CPU or in addition to the CPU, programmable logic devices such as a DSP (Digital Signal Processing or Processor), an FPGA (Field Programmable Gate Array), and the like. In addition, the processor 100 can include a plurality of processors or CPUs that execute the processing sequences of the present disclosure together.

The driver 1001 drives the vibrator 101. More specifically, the driver 1001 is an electronic circuit for driving the vibrator 101. For example, the driver 1001 includes an integrated circuit for driving the vibrator 101. The processor 100 inputs the first signal SL1 to the driver 1001. The driver 1001 applies a drive voltage to the vibrator 101 based on the input first signal SL1. The driver 1001 vibrates the vibrator 101 at a prescribed frequency (for example, a frequency of 100 times per second) based on the first signal SL1. As a result of the driver 1001 vibrating the vibrator 101 at a prescribed frequency (for example, a frequency of 100 to 300 times per second), the user can readily recognize the generated vibration. In addition, the driver 1001 vibrates the vibrator 101 at a prescribed drive cycle (for example, a drive cycle of once every 0.5 seconds) based on the first signal SL1. For example, the vibrator 101 generates vibrations having a frequency of 100 times per second at an interval of once every 0.5 seconds. In this way, the user can recognize vibrations that are generated at prescribed intervals. The frequency of the vibrator 101 is not limited to a frequency of 100 to 300 times per second. The vibrator 101 can vibrate at any frequency as long as the vibrations are recognizable by the user of the shoulder-mounted speaker 10. Thus, in the illustrated embodiment, the first signal SL1 is indicative of at least one of the prescribed frequency of the vibration of the vibrator 101 and the prescribed drive cycle of the vibrator 101.

The vibrator 101 is a hardware device that vibrates based on the drive voltage from the driver 1001. That is, the vibrator 101 vibrates based on the first signal SL1 input from the processor 100. The vibrator 101 vibrates with a prescribed frequency (for example, at a frequency of 100 times per second) by means of the drive voltage of the driver 1001. The vibrator 101 is, for example, a pendulum-type motor. The pendulum-type motor is also known as a vibration motor or actuator, such as an eccentric rotating mass (ERM) vibration motor. The pendulum-type motor is smaller in size than the shoulder-mounted speaker 10 (for example, about 5 cubic centimeters). It is thus possible to place the pendulum-type motor in the shoulder-mounted speaker 10 as the vibrator 101. The pendulum-type motor is lighter in weight than the shoulder-mounted speaker 10 (about 20 g). In the present embodiment, the center of gravity of the pendulum-type motor is located in a different position than the center of the rotary shaft of the motor. Vibrations are thus generated when the pendulum-type motor rotates.

It is not necessary for the vibrator 101 to be the pendulum-type motor. The vibrator 101 can be any device that can produce vibrations. The vibrator 101 can be any device that is smaller than the shoulder-mounted speaker 10. For example, the vibrator 101 can be a transducer, such as a piezoelectric body (for example, a piezoelectric element). The piezoelectric body is smaller in size than the pendulum-type motor (the piezoelectric body is thinner than the pendulum-type motor). The piezoelectric body is lighter in weight than the pendulum-type motor. The piezoelectric body is a device that converts the input first signal SL1 into vibrations (more specifically, a device that generates vibrations based on the voltage of the first signal SL1). In this case, the driver 1001 controls the piezoelectric body such that the piezoelectric body vibrates at a prescribed frequency and at a prescribed drive cycle.

When the pendulum-type motor and the piezoelectric body are compared, the pendulum-type motor vibrates more intensely than the piezoelectric body. However, the pendulum-type motor is larger than the piezoelectric body, and the pendulum-type motor is heavier than the piezoelectric body. On the other hand, when the pendulum-type motor and the piezoelectric body are compared, the piezoelectric body is smaller than the pendulum-type motor and the piezoelectric body is lighter than the pendulum-type motor. However, the piezoelectric body vibrates less intensely than the piezoelectric body. Therefore, if it is desired to provide to the user of the shoulder-mounted speaker 10 that generates vibrations that can be readily recognized, then the vibrator 101 can be formed of the pendulum-type motor. If it is desired to provide to the user a small and lightweight shoulder-mounted speaker 10 that can easily be worn, then the vibrator 101 can be formed of the piezoelectric body. Of course, the vibrator 101 can be any types of vibration motors or actuators, such as linear resonant actuators (LRAs), solenoid actuators, and the like.

The processor 100 inputs the second signal SL2 to the D/A converter 1002. The D/A converter 1002 then converts the second signal SL2, which is a digital signal, into the analog form of the second signal SL2. After conversion, the D/A converter 1002 outputs the second signal SL2 that has been converted into an analog signal to the amplifier 1003. In the illustrated embodiment, the D/A converter 1002 can be any types of electronic circuits for converting a digital signal into an analog signal.

The amplifier 1003 receives the second signal SL2 that has been converted into an analog signal from the D/A converter 1002. The amplifier 1003 then amplifies the second signal SL2 that has been converted into an analog signal. The amplifier 1003 outputs the amplified second signal SL2 to the speaker 102. In the illustrated embodiment, the amplifier 1003 can be any types of electronic circuits, such as audio amplifier ICs, for amplifying the analog signal.

The speaker 102 is an audio device or equipment that emits sounds based on the amplified second signal SL2 input from the amplifier 1003. In other words, the speaker 102 emits sounds based on the second signal SL2 input from the processor 100 via the DA converter 1002 and the amplifier 1003. That is, the speaker 102 emits sounds based on the second signal SL2 input from the processor 100. Here, the second signal SL2, which is a sound signal, can be an analog signal obtained by converting sound into an electronic signal. In this case, it is not necessary for the shoulder-mounted speaker 10 to be provided with the D/A converter 1002. In the case of this configuration, the processor 100 acts, for example, as an electronic circuit that processes the analog signal. The processor 100 outputs the second signal SL2, which is an analog signal, to the amplifier 1003. The amplifier 1003 amplifies, and outputs the second signal SL2, which is an analog signal, to the speaker 102.

The processing sequence with respect to the shoulder-mounted speaker 10 will now be described. First, the processing sequence of the first signal SL1 in the shoulder-mounted speaker 10 will be described. First, the processor 100 first acquires the first signal SL1 (FIG. 2A: S11). The processor 100 then outputs the first signal SL1 to the driver 1001 (FIG. 2A: S12). The driver 1001 applies a drive voltage for driving the vibrator 101 based on the input first signal SL1 (FIG. 2A: S13). The vibrator 101 vibrates based on the drive voltage from the driver 1001 (FIG. 2A: S14). The processor 100 repeats the processing of S11 to S14.

Next, the processing sequence of the second signal SL2 in the shoulder-mounted speaker 10 will be described. First, the processor 100 acquires the second signal SL2 (FIG. 2B: S21). The processor 100 then outputs the second signal SL2 to the D/A converter 1002 (FIG. 2B: S22). The D/A converter 1002 then carries out the D/A conversion of the second signal SL2 (FIG. 2B: S23), The D/A converter 1002 thereby obtains the second signal SL2 that has been converted into an analog signal. The D/A converter 1002 then outputs the second signal SL2 that has been D/A converted to the amplifier 1003 (FIG. 2B: S24). The amplifier 1003 then amplifies the second signal SL2 (FIG. 2B: 525). The amplifier 1003 then outputs the second signal SL2 to the speaker 102 (FIG. 2B: S26). Finally, the speaker 102 emits sound based on the second signal SL2 input from the amplifier 1003 (FIG. 2B: S27). The shoulder-mounted speaker 10 repeats the processing of S21 to S27.

The vibration generation interval can be determined based on a setting received from the user, for example. The user sets the vibration generation interval in accordance with the rhythm of the musical piece.

The processor 100 can process either the first signal SU or the second signal SL2 first. For example, the processor 100 can acquire the first signal SL1 and the second signal SL2 in that order, or acquire the second signal SL2 and the first signal SL1 in that order. In addition, the processor 100 can output the first signal SL1 and the second signal SL2 in that order, or output the second signal SL2 and the first signal SL1 in that order, for example. However, regardless of the order in which the first signal SL1 and the second signal SL2 are processed, the vibrations of the vibrator 101 and the rhythm of the sound emitted from the speaker 102 match.

### Example of Connection Between Shoulder-Mounted Speaker and External Device

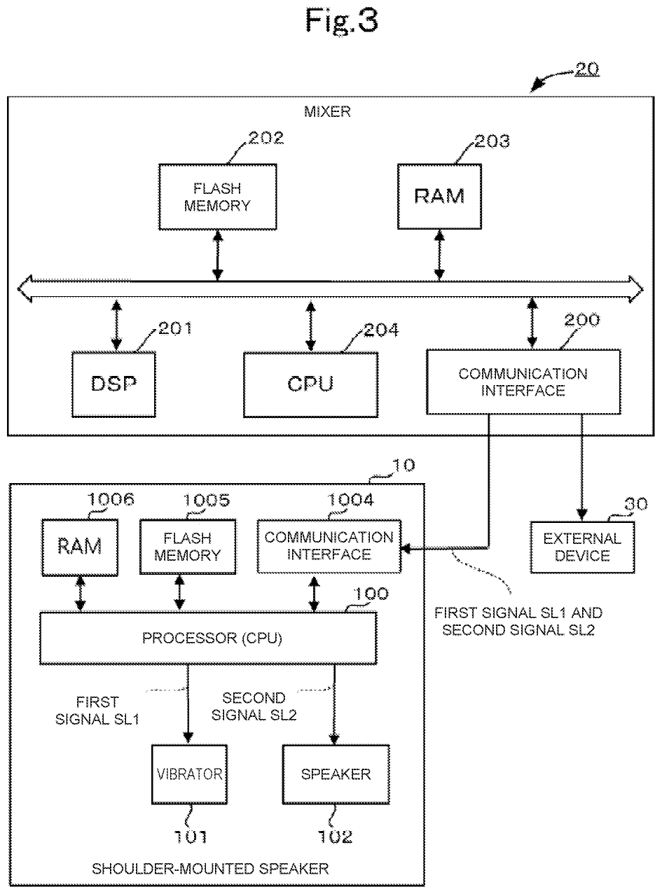

An example of a connection between the shoulder-mounted speaker 10 and the external device ExD will be described below with reference to the drawings. FIG. 3 is a block diagram illustrating one example of the connection between the shoulder-mounted speaker 10 and the external device ExD.

As shown in FIG. 3, the shoulder-mounted speaker 10 is connected to a mixer 20 (one example of the external device ExD), for example. In this case, the shoulder-mounted speaker 10 acquires the first signal SL1 and the second signal SL2 input from the mixer 20 via the communication interface 1004. The mixer 20 is, specifically, an electronic device that adjusts sound signals, outputs sound signals and control signals, and the like. As shown in FIG. 3, the mixer 20 comprises a communication interface 200, a DSP (Digital Signal Processor) 201, a flash memory 202, a RAM (Random Access Memory) 203, and a CPU 204.

The communication interface 200 communicates with a device (including an audio device) that differs from the mixer 20. The shoulder-mounted speaker 10 and the mixer 20 are connected to each other by wire, such as by means of an audio cable, or wirelessly, such as by means of Wi-Fi (registered trademark), Bluetooth (registered trademark), or the like. As shown in FIG. 3, the mixer 20 communicates with the shoulder-mounted speaker 10 via the communication interface 200. Specifically, the communication interface 200 of the mixer 20 outputs the first signal SL1 and the second signal SL2 to the communication interface 1004 of the shoulder-mounted speaker 10. The communication interface 200 is, for example, a USB or an HDMI (registered trademark). The shoulder-mounted speaker 10 and the mixer 20 can be connected by an interface such as an audio interface, a MIDI interface, or the like. In this case, the audio interface sends and receives the second signal SL2, and the MIDI interface sends and receives the first signal SL1. Thus, in the illustrated embodiment, the communication interface 200 is a hardware device capable of transmitting the first signal SL1 and the second signal SL2 and can communicate with the communication interface 1004.

The DSP 201 generates the second signal SL2 by signal processing the input sound signal. Signal processing is, for example, a process such as mixing or applying effects. Following signal processing, the second signal SL2 is output to a device external to the mixer 20 via the communication interface 200.

Various programs are stored in the flash memory 202. Various programs include, for example, programs for operating the mixer 20.

A prescribed program stored in the flash memory 202 can be temporarily stored in RAM 203.

The CPU 204 controls the operation of the mixer 20. Specifically, the CPU 204 reads a prescribed program stored in the flash memory 202 into RAM 203 in order to carry out various operations, It is not necessary that the program be stored in the flash memory 202 inside the mixer 20, For example, the CPU 204 downloads a program from a device external to the mixer 20 via a network. The CPU 204 can then read the downloaded program into RAM 203.

The CPU 204 generates the first signal SL1 for the driver 1001 to drive the vibrator 101. The CPU 204 receives a setting of the rhythm of the vibrations from the user. The CPU 204 generates the first signal SL1 in accordance with the received rhythm setting. Then, the CPU 204 outputs the generated first signal SL1 to the shoulder-mounted speaker 10 via the communication interface 200.

The CPU 204 can generate the first signal SL1 based on a sound signal, for example. For example, if a sound of a bass drum is included in the sound signal, the CPU 204 generates the first signal SL1 at the timing with which the bass drum sound is played. The shoulder-mounted speaker 10 can thereby vibrate the vibrator 101 in accordance with the bass drum sound that is reproduced by the speaker 102. In this case, the first signal SL1 is a signal calculated from the sound signal and a signal that drives the vibrator 101 at a prescribed frequency and at a prescribed drive cycle.

The external device ExD connected of the shoulder-mounted speaker 10 is not limited to the example of the mixer 20. The external device ExD can be a PC or a smartphone, for example. In that case, the shoulder-mounted speaker 10 is connected to the PC or a smartphone via the communication interface 1004. Further, here, the PC or a smartphone outputs the first signal SL1 and the second signal SL2. The shoulder-mounted speaker 10 acquires the first signal SL1 and the second signal SL2 from the PC or a smartphone via the communication interface 1004.

### Appearance of Shoulder-Mounted Speaker

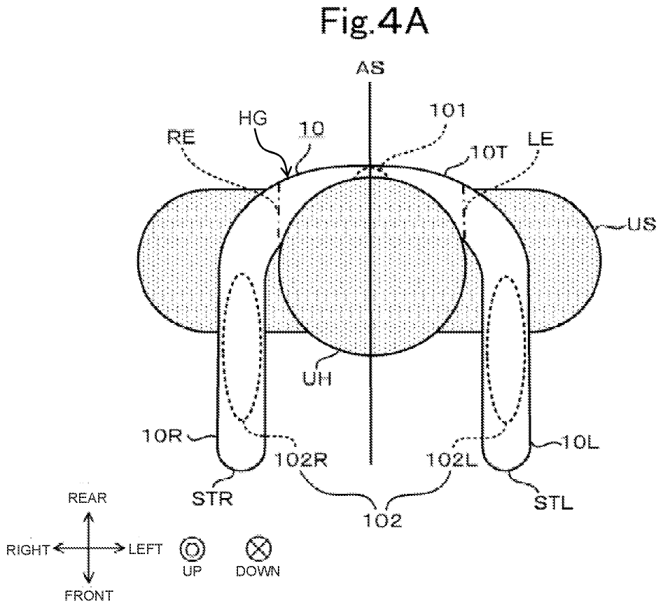

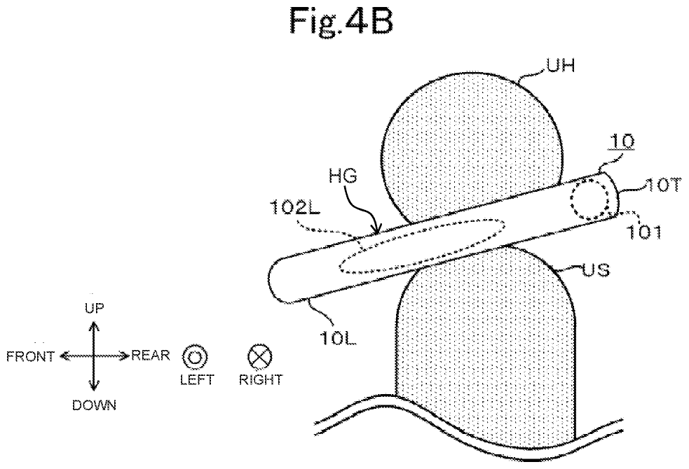

The appearance of the shoulder-mounted speaker 10 according to the first embodiment will be described below with reference to the drawings. FIG. 4A is a top view showing the appearance of the shoulder-mounted speaker 10 according to the first embodiment. FIG. 4B is a left side view showing the appearance of the shoulder-mounted speaker 10 according to the first embodiment The speaker 102 and the vibrator 101 are located inside the shoulder-mounted speaker 10.

As shown in FIGS. 4A and 4B, the shoulder-mounted speaker 10 is used while placed on the user's shoulders US. Thus, the shoulder-mounted speaker 10 includes a contact portion, which is the portion that comes into contact with the user's shoulders US. The user can thereby recognize the vibrations that are generated by the shoulder-mounted speaker 10 via the contact portion. Here, the downward direction is defined as the vertically downward direction in a state in which the shoulder-mounted speaker 10 is placed on the user's shoulders US. In addition, the upward direction is defined as the vertically upward direction in a state in which the shoulder-mounted speaker 10 is placed on the user's shoulders US.

The shoulder-mounted speaker 10 has an essentially U-shape in plan view, as seen in FIG. 4A. As a result, as shown. in FIGS. 4A and 4B, when the shoulder-mounted speaker 10 is placed on the user's shoulders US, the shoulder-mounted speaker 10 is disposed so as to surround the user's neck in plan view. More specifically, as shown. in FIGS. 4A and 4B, the shoulder-mounted speaker 10 includes a housing or enclosure HG having a rear portion 10T, a right portion 10R, and a left portion 10L that are arranged so as to surround the user's neck. Furthermore, as shown in FIG. 4A, the housing HG of the shoulder-mounted speaker 10 has two distal end portions STR, STL, which are portions corresponding to the distal ends of the U shape. The distal end portions STR, STL of the shoulder-mounted speaker 10 mean the distal ends of the shoulder-mounted speaker 10 and the vicinity thereof.

Here, as shown in FIG. 4A, When the user wears the shoulder-mounted speaker 10, the direction in which the user's head UH and the rear portion 10T are arranged with respect to each other is defined as the front-rear direction in plan view. In particular, the direction in which the user's head UH and the rear portion 10T are arranged in this order is the rearward direction. Also, the direction orthogonal to the vertical direction and the front-rear direction is defined as the left-right or lateral direction.

As shown in FIG. 4A, the rear portion 10T is located behind the user's neck. The width of the rear portion 10T in the left-right direction is greater than the width of the rear portion 10T in the front-rear direction.

The right portion 10R is located to the right of the user's neck in plan view. Specifically, the right portion 10R is located to the right of the user's neck when the user wears the shoulder-mounted speaker 10 such that the rear portion 10T is located behind the user's neck. As shown in FIG. 4A, the right portion 10R is a long portion that extends forward from the right end RE of the rear portion 10T. That is, as shown in FIG. 4A, the shoulder-mounted speaker 10 is shaped so as to bend forward at the right end RE of the rear portion 10T.

The left portion 10L is located to the left of the user's neck in plan view. Specifically, the left portion 10L is located to the left of the user's neck when the user wears the shoulder-mounted speaker 10 such that the rear portion 10T is located behind the user's neck. As shown in FIGS. 4A and 4B, the left portion 10L is a long portion that extends forward from the left end LE of the rear portion 10T. That is, as shown in FIG. 4A, the shoulder-mounted speaker 10 is shaped so as to bend forward at the left end LE of the rear portion 10T.

As shown in FIGS. 4A and 4B, the vibrator 101 is located in the rear portion 10T. As a result, the vibrator 101 of the shoulder-mounted speaker 10 is located near the user's neck. Therefore, the user can readily recognize the vibrations generated by the vibrator 101.

In the example shown in FIG. 4A, the shoulder-mounted speaker 10 includes two speakers. Specifically, the speaker 102 of the shoulder-mounted speaker 10 includes a right speaker 102R located in the right portion 10R and a left speaker 102L located in the left portion 10L. The right speaker 102R and the left speaker 102L each include a speaker unit or driver that are dimensioned to be accommodated within the housing HG (the right portion 10R and the left portion 10L).

When the user wears the shoulder-mounted speaker 10, the right speaker 102R is located to the right of the user's neck. The right speaker 102R emits sound in the upward direction. As a result, sound is generated from the right speaker 102R toward the direction in which the user's right ear is located. As a result, the user can readily hear the sounds generated from the right speaker 102R. Other than being located in the left portion 10L, the left speaker 102L is configured in the same manner as the right speaker 102R, so that the description thereof is omitted. In the case of the above-described configuration, the speaker 102 provided in the shoulder-mounted speaker 10 includes the right speaker 102R and the left speaker 102L. In the illustrated embodiment, the right speaker 102R and the left speaker 102L can operate as stereo speakers to output respective channels of the sound signal. Specifically, the right speaker 102R outputs sounds based on a right channel of the sound signal (i.e., a right channel of the second signal SL2), while the left speaker 102L outputs sounds based on a left channel of the sound signal (i.e., a left channel of the second signal SL2). Of course, the right speaker 102R and the left speaker 102L can be used to output the same sound based on a single channel of the sound signal.

The shoulder-mounted speaker 10 is symmetrical. More specifically, as shown in FIG. 4A, a straight line AS that is located on the rear portion 10T and that is parallel to the front-rear direction is defined. In particular, the straight line AS extends across the rear portion 10T and defines a center line of the shoulder-mounted speaker 10. At this time, the shoulder-mounted speaker 10 is symmetrical with respect to the straight line AS. In particular, the housing HG of the shoulder-mounted speaker 10 is symmetrical with respect to the straight line AS. Furthermore, in the illustrated embodiment, the right speaker 102R and the left speaker 102L are symmetrically arranged relative to each other with respect to the straight line AS. On the other hand, the speaker 102 is asymmetrically arranged relative to the vibrator 101 with respect to the straight line AS. In particular, as mentioned above, the right speaker 102R and the left speaker 102L are disposed inside the right portion 10R and the left portion 10L, respectively, while the vibrator 101 is disposed inside the rear portion 10T. In the illustrated embodiment, the processor 100, the driver 1001, the D/A converter 1002, the amplifier 1003, the communication interface 1004, the flash memory 1004 and the RAM 1006 are mounted on an electronic circuit board (not shown). Although the electronic circuit board is not shown in FIGS. 4A and 4B, the electronic circuit board can be disposed at a suitable location within the housing HG for being electrically connected to the vibrator 101 and the speaker 102. Of course, in some cases, the vibrator 101 and the speaker 102 can be mounted on the electronic circuit board. Furthermore, in some cases, the processor 100, the driver 1001, the D/A converter 1002, the amplifier 1003, the communication interface 1004, the flash memory 1004 and the RAM 1006 can also be mounted on a plurality of separate electronic circuit boards, as needed and/or desired.

### Effect of First Embodiment

By means of the shoulder-mounted speaker 10 according to the first embodiment, the user can readily recognize the rhythm of the sound reproduced from the speaker 102. More specifically, the shoulder-mounted speaker 10 has the processor 100, the vibrator 101, and the speaker 102. The processor 100 acquires the first signal SL1, which is a signal for driving the vibrator 101 (for example, a control signal for controlling a motor) and the second signal SL2, which is a sound signal. The vibrator 101 vibrates based on the first signal SL1 input from the processor 100. The speaker 102 emits sounds based on the second signal SL2 input from the processor 100. By means of the above-described configuration, the user can recognize the vibrations generated by the vibrator 101 in addition to the sounds generated from the speaker 102. In this case, the user can recognize the vibrations generated by the vibrator 101 in addition to the sounds generated from the speaker 102. Therefore, by vibrating the vibrator 101 at a timing that matches the rhythm of the sound (for example, by vibrating the vibrator 101 at the beginning of the beats of the reproduced sound), the user can recognize the rhythm based on two pieces of information, sound and vibration. As a result, the user can readily recognize the rhythm of the reproduced sound.

In addition, the vibrator 101 in the shoulder-mounted speaker 10 vibrates. Therefore, it is not necessary to increase the level of the sound signal in order to make the rhythm of the sound generated from the speaker 102 easier to recognize. If the level of the sound signal is increased in order to make the rhythm of the sound easier to recognize, the volume of the reproduced sound increases. In this case, the user is less able to hear ambient sounds, and the like, around the user due to the increased volume of the sound. That is, the user is hindered from recognizing the ambient sound around the user due to the increased volume of the sound. On the other hand, in the case that vibrations are generated by the vibrator 101, it is not necessary to increase the level of the sound signal in order to make the rhythm of the sound easier to recognize. That is, the user is not hindered from recognizing the ambient sound around the user due to the increased volume. Therefore, the user can recognize the rhythm of the sound reproduced from the speaker 102 while recognizing the ambient sound around the user.

By means of the shoulder-mounted speaker 10, the user can readily recognize the rhythm of the sound reproduced from the speaker 102. More specifically, the shoulder-mounted speaker 10 includes the rear portion 10T located behind the user's neck. In addition, the vibrator 101 is located in the rear portion 10T. The rear portion 10T is part of the shoulder-mounted speaker 10 that tends to come in contact with the user. That is, the user's neck is located in the vicinity of the vibrator 101, which is the source of the vibrations. Therefore, the vibrations generated by the vibrator 101 are easily transmitted to the user. As a result, the user can readily recognize the vibrations generated by the vibrator 101. That is, the user can readily recognize the rhythm of the reproduced sound.

When a pendulum-type motor or a piezoelectric body is used for the vibrator 101 in the shoulder-mounted speaker 10, it becomes possible to reduce the size of the shoulder-mounted speaker 10 and to make it easy to vibrate the shoulder-mounted speaker 10. More specifically, the pendulum-type motor or the piezoelectric body is smaller in size than the shoulder-mounted speaker 10. The vibrator 101 can thereby be disposed inside the shoulder-mounted speaker 10. In other words, it is not necessary to dispose the vibrator 101 on the outer surface of the shoulder-mounted speaker 10. Therefore, it becomes possible to reduce the size of the shoulder-mounted speaker 10. Moreover, by reducing the size of the shoulder-mounted speaker 10, it is possible to reduce the weight of the shoulder-mounted speaker 10. Therefore, the vibrator 101 makes it easier for the shoulder-mounted speaker 10 to vibrate. In addition, the pendulum-type motor or the piezoelectric body is lighter in weight than the shoulder-mounted speaker 10. Therefore, the weight of the vibrator 101 does not cause the magnitude of the vibrations generated in the shoulder-mounted speaker 10 to become smaller. As a result, the user can readily recognize the vibrations generated in the shoulder-mounted speaker 10.

### Second Embodiment

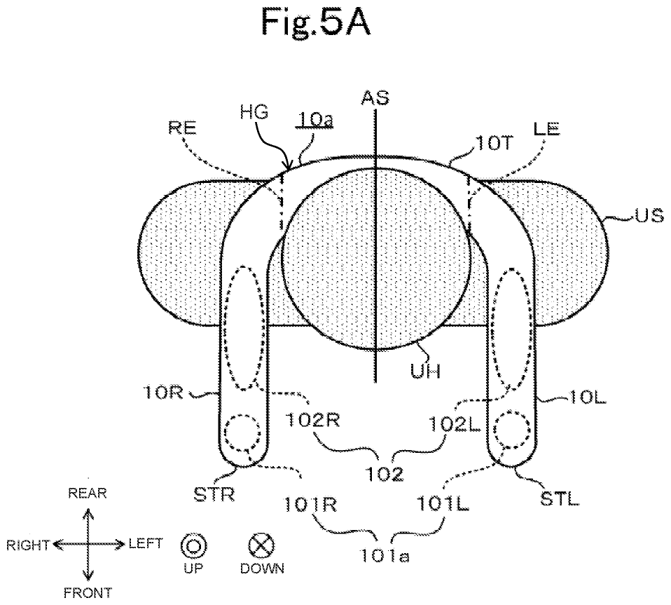

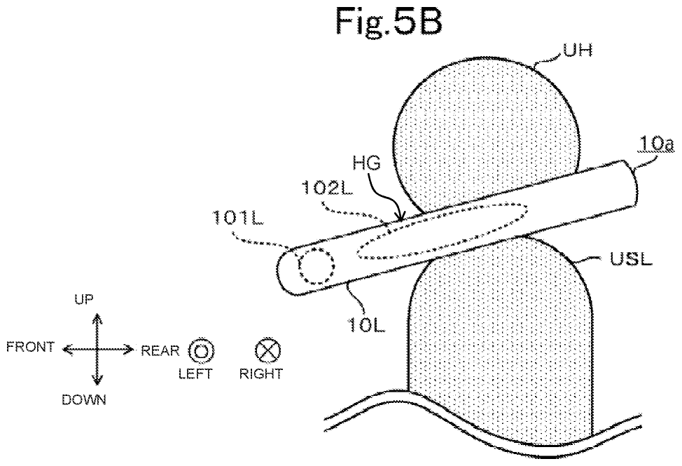

A shoulder-mounted speaker 10a according to a second embodiment will be described below with reference to the drawings. FIG. 5A is a top view showing the appearance of the shoulder-mounted speaker 10a according to the second embodiment. FIG. 5B is a left side view showing the appearance of the shoulder-mounted speaker 10a. according to the second embodiment. Components that are the same as those of the shoulder-mounted speaker 10 have been assigned the same reference symbols, and their descriptions have been omitted.

The shoulder-mounted speaker 10a is basically the same as the shoulder-mounted speaker 10, but differs from the shoulder-mounted speaker 10 in terms of vibrator location. Specifically, as shown in FIGS. 5A and 5B, vibrators (a right vibrator 101R and a left vibrator 101L) are respectively disposed in the right portion 10R and the left portion 10L. In the illustrated embodiment, the right vibrator 101R and the left vibrator 101L are the same type of vibrator as the vibrator 101 shown in FIGS. 4A and 4B. However, the right vibrator 101R and the left vibrator 101L can be a different type of vibrator from the vibrator 101. Also, the right vibrator 101R and the left vibrator 101L can be different types of vibrators, respectively.

As shown in FIG. 5A, the right vibrator 101R is located in the right portion 10R. In the example shown in FIGS. 5A and 5B, the right vibrator 101R is located at the distal end portion STR of the shoulder-mounted speaker 10a.

As shown in FIGS. 5A and 5B, the left vibrator 101L is located in the left, portion 10L. In the example shown in FIGS. 5A and 5B, the left, vibrator 101L is located at the distal end portion STL of the shoulder-mounted speaker 10a.

### Effect of Second Embodiment

By means of the shoulder-mounted speaker 10a, the user can readily recognize the rhythm of the reproduced sound. More specifically, the shoulder-mounted speaker 10a includes the right portion 10R. The right portion 10R is located to the right of the user's neck. In addition, the right portion 10R is bent forward from the right end RE of the rear portion 10T. The right vibrator 101R is located in the right portion 10R. In the case of the above-described configuration, the right vibrator 101R is located in the shoulder-mounted speaker 10a away from the rear portion 10T. In this case, the distance between the right vibrator 101R, which is the source of vibrations, and the rear portion 10T, which is the fulcrum of the shoulder-mounted speaker 10a, is increased. As a result, when the right vibrator 101R vibrates, the right portion 10R tends to shake in the vertical direction or the left-right direction due to the vibrations. As a result, the user can readily recognize the shaking of the shoulder-mounted speaker 10a corresponding to the reproduced sound. Therefore, the user can readily recognize the rhythm of the reproduced sound. For the same reason, when the left vibrator 101L is located in the left portion 10L of the shoulder-mounted speaker 10a, the user can readily recognize the rhythm of the reproduced sound.

### Third Embodiment

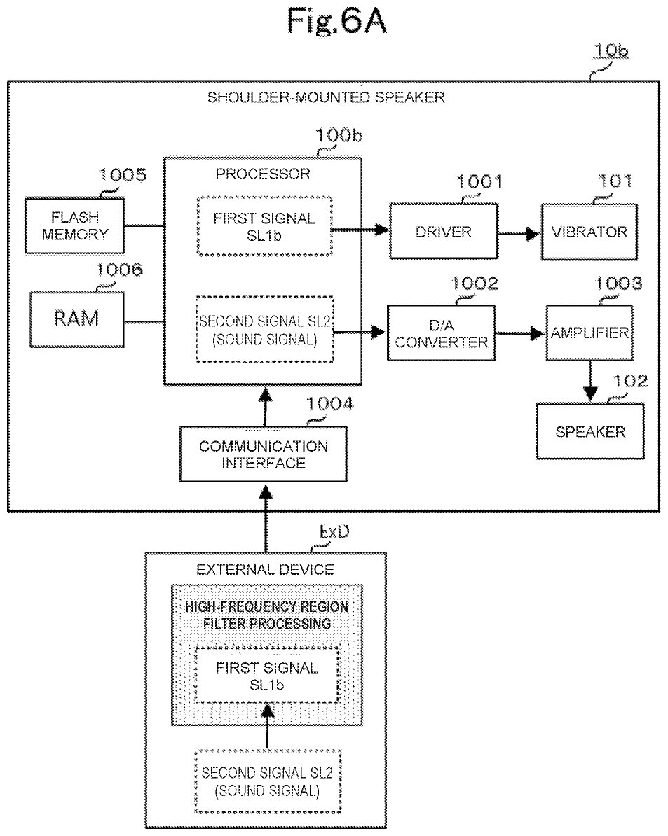

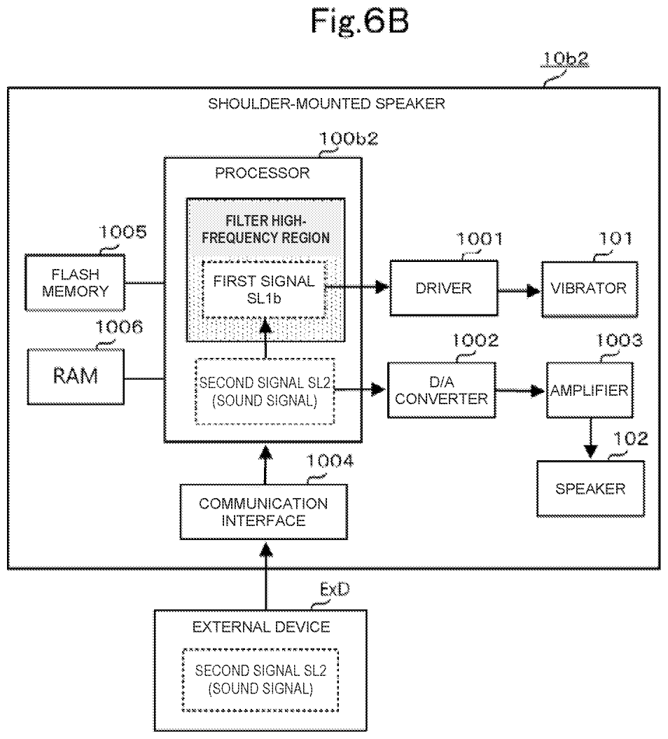

Configurations of shoulder-mounted speakers 10b, 10b2 according to a third embodiment will be described below with reference to the drawings. FIG. 6A is a block diagram illustrating a configuration of the shoulder-mounted speaker 10b according to the third embodiment. FIG. 6B is a block diagram illustrating a configuration of the shoulder-mounted speaker 10b2 according to the third embodiment.

As shown in FIG. 6A, the shoulder-mounted speaker 10b is basically the same as the shoulder-mounted speaker 10, but differs from the shoulder-mounted speaker 10 in that the high-frequency region of the acquired sound signal has been filtered. Specifically, the driver 1001 of the shoulder-mounted speaker lob receives an input of a signal based on a sound signal. The driver 1001 then drives the vibrator 101 based on the input signal (the signal based on a sound signal).

A more detailed description follows. First, as shown in FIG. 6A, the external device ExD filters (for example, filtering using a low-pass filter) the high-frequency region of the second signal SL2, which is a sound signal, thereby generating a first signal SL1b. That is, the first signal SL1b is a sound signal with its high-frequency region being filtered. The shoulder-mounted speaker 10b acquires the first signal SL1b and the second signal SL2 from the external device ExD. A processor 100b then outputs the first signal SL1b to the driver 1001 and outputs the second signal SL2 to the speaker 102. The driver 1001 controls the vibrator 101 based on the first signal SL1b. The vibrator 101 vibrates (drives) based on the control of the driver 1001. The speaker 102 emits a sound based on the second signal SL2. By means of the above-described configuration, the vibrator 101 vibrates based on a signal that is limited to low-frequency sounds, such as the sound of a bass drum, due to the low-pass filtering. Therefore, intense vibrations corresponding to sounds that create rhythms, such as the sounds of a bass drum, tend to be generated by the vibrator 101. Except for that the vibrator 101 vibrates based on the first signal SL1b with its high-frequency region being filtered, the shoulder-mounted speakers 10b, 10b2 are configured in the same manner as the shoulder-mounted speaker 10. Thus, descriptions of components that are the same as those of the shoulder-mounted speaker 10 have been omitted.

As shown in FIG. 6B, the shoulder-mounted speaker according to the present embodiment can be the shoulder-mounted speaker 10b2 that carries out a filter processing of the high-frequency region of the sound signal. In this case, the flash memory 1005 of the shoulder-mounted speaker 10b2 stores a program for filter processing. Then, a processor 100b2 reads a program for filter processing from the flash memory 1005 in order to carry out the filter processing. In the case of the above-described configuration, the shoulder-mounted speaker 10b2 acquires the second signal SL2, which is a sound signal, from the external device ExD. The processor 100b2 of the shoulder-mounted speaker 10b2 then filters the high-frequency region of the second signal SL2, thereby generating the first signal SL1b. The processor 100b2 then outputs the filtered first signal SL1b to the driver 1001.

### Effects of Third Embodiment

By means of the shoulder-mounted speakers 10b, 10b2, the user can recognize vibrations similar to the vibrations generated by sound. More specifically, the high-frequency region of the first signal SL1b that is utilized by the shoulder-mounted speaker 10b, 10b2 has been filtered. In this case, the vibrator 101 vibrates in accordance with the low-frequency region of the sound signal. Therefore, vibrations similar to the vibrations generated by low-frequency sounds are generated by the vibrator 101. As a result, the user can recognize the vibrations similar to the vibrations generated by the sound.

### Fourth Embodiment

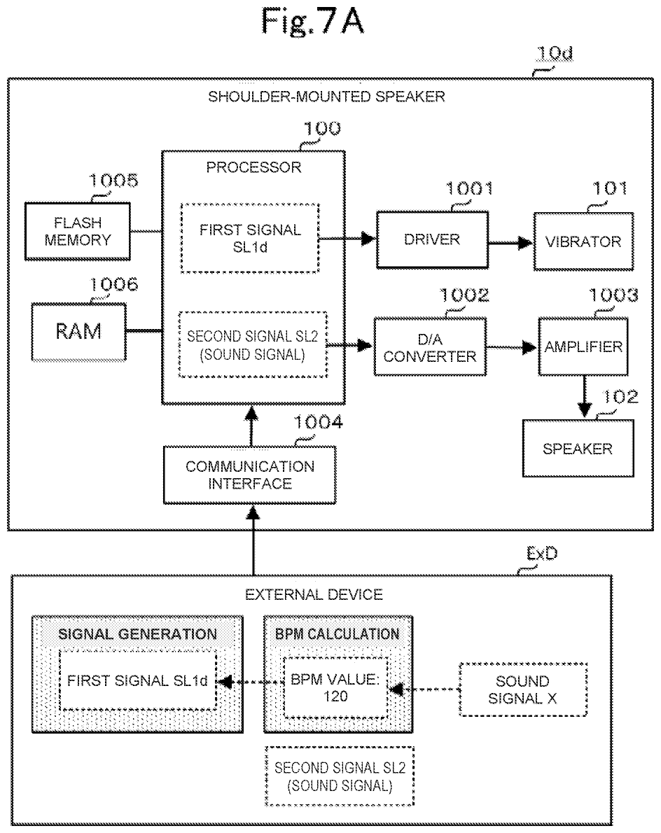

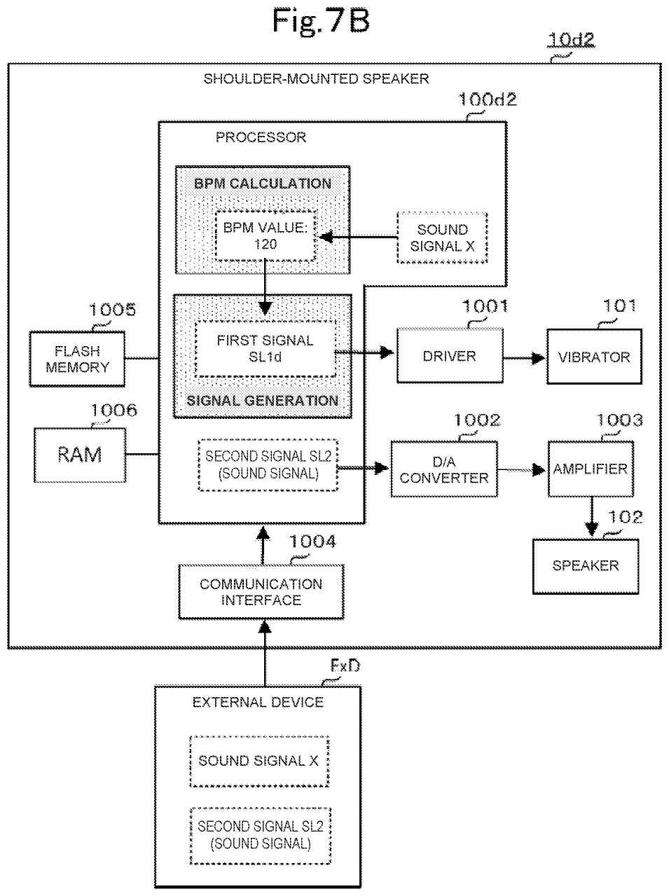

Configurations of shoulder-mounted speakers 10d, 10d2 according to a fourth embodiment will be described below with reference to the drawings. FIG. 7A is a block diagram illustrating the configuration of the shoulder-mounted speaker 10d according to the fourth embodiment. FIG. 7B is a block diagram illustrating the configuration of the shoulder-mounted speaker 10d2 according to the fourth embodiment.

As shown in FIG. 7A, the shoulder-mounted speaker 10d is basically the same as the shoulder-mounted speaker 10, but differs from the shoulder-mounted speaker 10 in that the vibrator 101 vibrates in accordance with a BPM (Beats Per Minute) value. The BPM value is calculated from a periodic signal.

A more detailed description follows. As shown in FIG. 7A, with the shoulder-mounted speaker 10d, the BPM of a sound signal X is calculated in the external device ExD. The sound signal X is one example of a periodic signal. The BPM is calculated by means of the following method, for example. After filtering the high-frequency region of the sound signal X, the external device ExD calculates the period of the signals of the filtered sound signal X whose power is at or above a prescribed threshold value and is also a local maximum value. Specifically, the external device ExD filters the high-frequency region of the sound signal in order to detect the signals of sounds that exhibit high power and that are generated at set timings. Sounds that exhibit high power and that are generated at set timings are, for example, the sound of a bass drum. The external device ExD then calculates the interval between the high-level sounds that are generated at a set cycle from the filtered signal. When the BPM value of the sound signal X is 120, for example, the external device ExD thus calculates “BPM value of sound signal X=120.” The method for calculating the BPM is not limited to the above-described method. For example, if the BPM value is included in the content data that is the basis of the second signal SL2, the external device ExD can acquire the BPM value.

After calculating the BPM, the external device ExD generates a first signal SL1d based on the BPM value. The first signal SL1d becomes a signal that causes the vibrator 101 to vibrate at the drive cycle corresponding to the BPM value. Specifically, when the BPM value=120, the first signal SL1d is a signal that causes the vibrator 101 to be driven at intervals of once every 0.5 seconds. The driver 1001 receives an input of the first signal SL1d from the processor 100. Then, the driver 1001 drives the vibrator 101 based on the first signal SL1d. The vibrator 101 thus vibrates at intervals of once every 0.5 seconds (that is, at a rhythm of BPM=120).

As shown in FIG. 7B, the shoulder-mounted speaker according to the present embodiment can be the shoulder-mounted speaker 10d2 that carries out a process for calculating the BPM. In this case, a program for calculating the BPM is stored in the flash memory 1005. In addition, in this case, a program for generating and processing signals is stored in the flash memory 1005. Then, a processor 100d2 reads the program for calculating the BPM and the program for generating and processing signals from the flash memory 1005, thereby acquiring the first signal SL1d. The processor 100d2 of the shoulder-mounted speaker 10b2 then outputs the first signal SL1d to the driver 1001. Thus, the vibrator 101 vibrates at a drive cycle corresponding to the BPM value.

### Effects of Fourth Embodiment

By means of the shoulder-mounted speaker 10d, 10d2, the user can readily recognize the rhythm of the sound reproduced from the speaker 102. More specifically, in the shoulder-mounted speakers 10d, 10d2, the vibrator 101 vibrates periodically according to the BPM value calculated from the sound signal X (is driven at a drive cycle according to the BPM value). If the vibrations generated by the vibrator 101 are periodic, the user can readily recognize the vibrations. In a scenario in which a musical piece is being played, the BPM value is an index with which it is particularly easy for the user to recognize the rhythm. Therefore, as a result of the vibrator 101 vibrating periodically in accordance with the BPM value, the user can readily recognize the rhythm of the reproduced sound.

### Fifth Embodiment

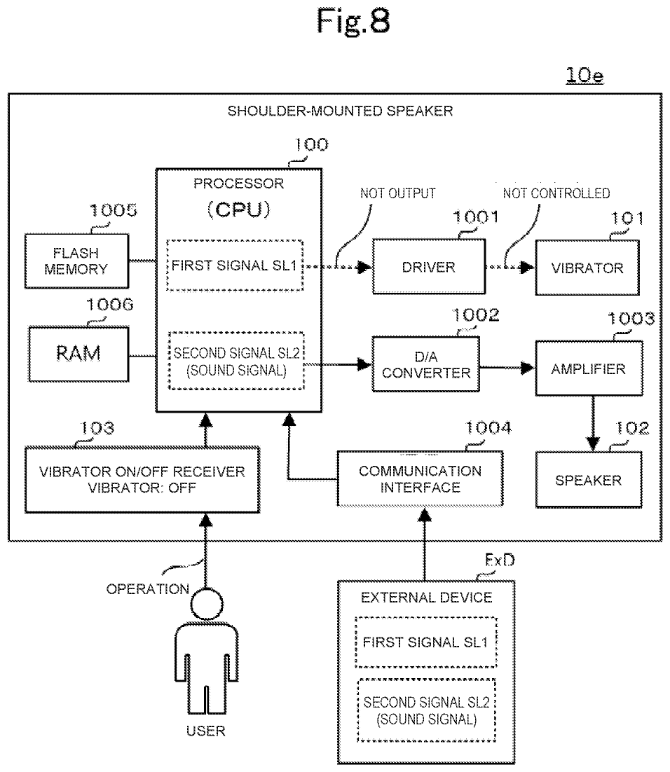

A shoulder-mounted speaker 10e according to a fifth embodiment will be described below with reference to the drawings. FIG. 8 is a block diagram illustrating the configuration of the shoulder-mounted speaker 10e according to the fifth embodiment. As shown in FIG. 8, the shoulder-mounted speaker 10e is basically the same as the shoulder-mounted speaker 10, but differs from the shoulder-mounted speaker 10 in that a vibrator on/off receiver (vibrator on/off reception unit) 103 is provided.

The vibrator on/off receiver 103 receives an operation to turn the vibrations of the vibrator 101 on or off. If the vibrator on/off receiver 103 receives a vibrator off operation from the user, as shown in FIG. 8, then the vibrator on/off receiver 103 commands the processor 100 to stop the output of the first signal SL1 to the driver 1001. Therefore, the driver 1001 does not control the vibrations of the vibrator 101. Thus, the vibrator 101 changes from a vibrating state to a non-vibrating state. On the other hand, if the vibrator on/off receiver 103 receives a vibrator on operation from the user, then the vibrator on/off receiver 103 commands the processor 100 to output the first signal SL1 to the driver 1001. Therefore, the driver 1001 controls the vibrations of the vibrator 101. As a result, the vibrator 101 changes from the non-vibrating state to the vibrating state.

The vibrator on/off receiver 103 is, for example, an electronic device such as a touch panel, an on/off switch, or the like. In other words, the vibrator on/off receiver 103 can be composed of any device that can receive an operation from the user.

### Effect of Fifth Embodiment

By means of the shoulder-mounted speaker 10e, the shoulder-mounted speaker 10e can be vibrated only when the user desires. More specifically, the shoulder-mounted speaker 10e comprises the vibrator on/off receiver 103 that receives an operation to turn the vibrations of the vibrator 101 on or off. As a result, when the user wishes to recognize the rhythm of a sound (for example, when the user wishes to recognize the rhythm of a musical piece that is being played during the playing of the musical piece), the user can input the vibrator on operation relative to the vibrator on/off receiver 103 to thereby generate vibrations. On the other hand, if the user does not wish to generate vibrations (for example, when the user wishes to focus on the playing of the musical piece after recognizing the rhythm of the musical piece), then the user can input the vibration off operation relative to the vibrator on/off receiver 103 to stop the vibrations. In this manner, by means of the vibrator on/off receiver 103, it is possible to provide the shoulder-mounted speaker 10e that can control the generation of vibrations in accordance with the user's intentions.

### Sixth Embodiment

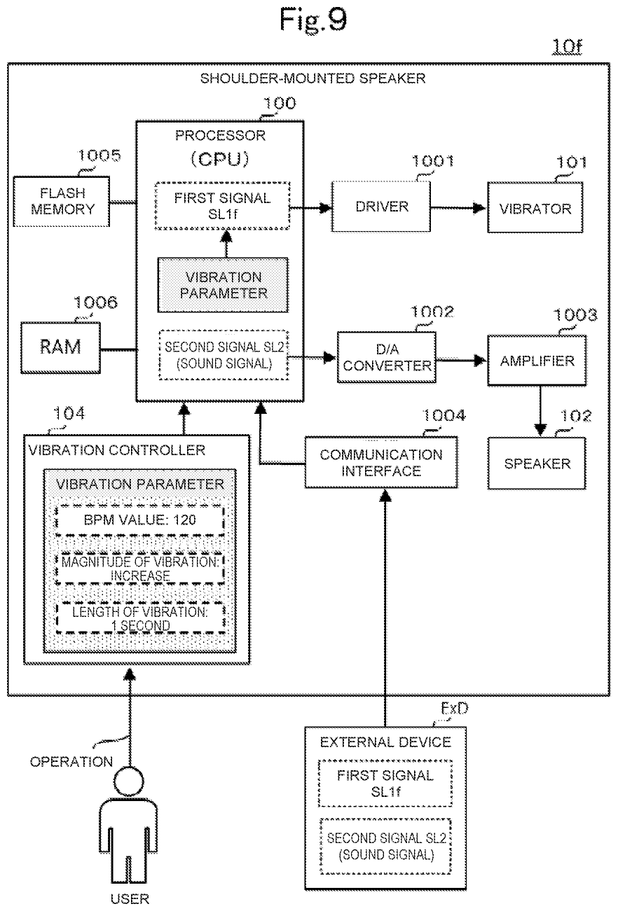

A shoulder-mounted speaker 10f according to a sixth embodiment will be described below with reference to the drawings. FIG. 9 is a block diagram illustrating a configuration of the shoulder-mounted speaker 10f according to the sixth embodiment.

As shown in FIG. 9, the shoulder-mounted speaker 10f is basically the same as the shoulder-mounted speaker 10, but differs from the shoulder-mounted speaker 10 in that a vibration controller (vibration control unit) 104 is provided. Then, in the shoulder-mounted speaker 10f, the vibrations of the vibrator 101 are controlled based on a vibration parameter input from the vibration controller 104. That is, the vibration controller 104 receives a vibration parameter for controlling the vibrations.

A vibration parameter includes at least one parameter for controlling the vibrations of the vibrator 101. The vibration parameter is input by the user. The vibration parameter includes at least one of the BPM value, the magnitude of vibration, and the length of one vibration. For example, if the vibration parameter is set to “BPM value=120” by the user, the processor 100 generates a periodic first signal SL1f that can vibrate the vibrator 101 at intervals of once every 0.5 seconds. For example, the processor 100 converts the first signal SL1f so as to include a pulse signal that is generated at intervals of once every 0.5 seconds. The first signal SL1f is then output to the driver 1001. The driver 1001 controls the vibrations of the vibrator 101 (drives the vibrator 101) based on the first signal SL1f. Thus, the shoulder-mounted speaker 10f can vibrate at a prescribed cycle set by the user. The magnitude of vibrations is the magnitude of the vibrations of the shoulder-mounted speaker 10f that are generated by the vibrator 101. When the magnitude of vibrations is set by the user, the processor 100 changes the signal level of the first signal SL1f. The driver 1001 then receives an input of the first signal SL1f whose signal level has been changed. The driver 1001 controls the vibrator 101 based on the first signal SL1f. For example, if the user increases the magnitude of the vibrations, the processor 100 increases the signal level of the first signal SL1f. The processor 100 inputs the first signal SL1f, which has an increased signal level, to the driver 1001. In this case, the driver 1001 increases the intensity of the vibrations of the vibrator 101 based on the first signal SL1f, which has an increased signal level. For example, if the vibrator 101 is the pendulum-type motor, the rotational speed of the pendulum-type motor is increased. The magnitude of vibrations of the vibrator 101 are thereby increased. The length of one vibration is the length of time from the start to the end of the vibration. For example, if the length of one vibration is set to 0.5 seconds, the shoulder-mounted speaker 10 continues to vibrate for 0.5 seconds per vibration. In this manner, the user can control the vibrations of the shoulder-mounted speaker 10f via the vibration controller 104.

### Effect of Sixth Embodiment

By means of the shoulder-mounted speaker 10f, it is possible to provide the shoulder-mounted speaker 10f that can be optimally tuned by the user. More specifically, the shoulder-mounted speaker 10f comprises the vibration controller 104. The vibration controller 104 receives the vibration parameter. The vibration parameter includes at least one parameter for controlling the vibration of the vibrator 101. The vibrations of the vibrator 101 are controlled based on the vibration parameter. By means of the above-described configuration, the user can control the vibration of the shoulder-mounted speaker 10f Therefore, the shoulder-mounted speaker 10f can generate the vibrations that the user desires. For example, the shoulder-mounted speaker 10f can input the BPM value set by the user via the vibration controller 104 and thereby generate vibrations at the cycle desired by the user. Similarly, the intensity of the vibrations can be increased or decreased, thereby generating vibrations with the intensity that the user desires. That is, it becomes possible to provide the shoulder-mounted speaker I Of that can be optimally tuned by the user.

### Seventh Embodiment

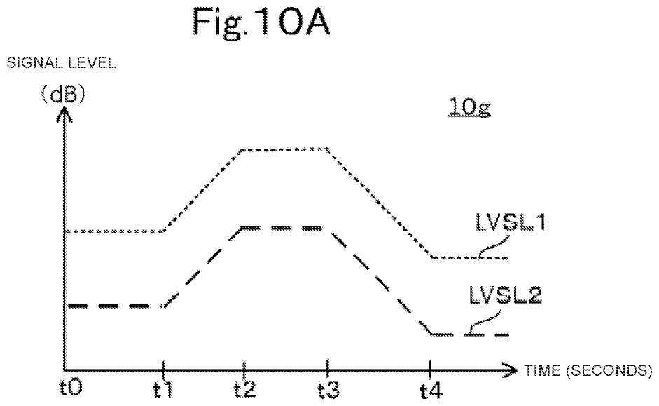

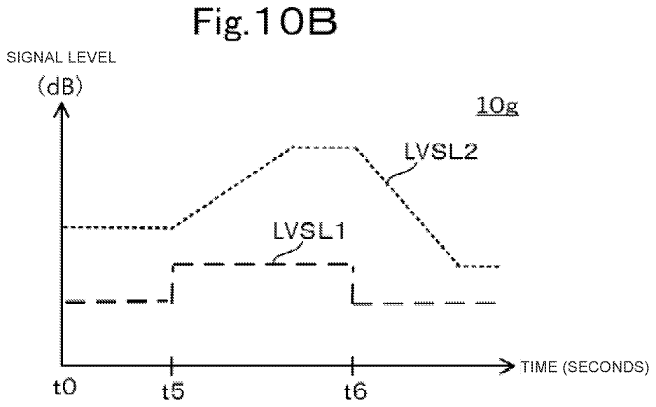

A shoulder-mounted speaker 10g according to a seventh embodiment will be described below with reference to the drawings. FIG. 10A is a graph showing one example of changes in the first signal SL1 and the second signal SL2 in the shoulder-mounted speaker 10g according to the seventh embodiment. FIG. 10B is a graph showing one example, which differs from the example shown in FIG. 10A, of changes in the first signal SL1 and the second signal SL2 in the shoulder-mounted speaker 10g according to the seventh embodiment. The horizontal axis and the vertical axis of the graph shown in FIGS. 10A and 10B represent time (seconds) and signal level (dB), respectively.

In the shoulder-mounted speaker 10g, a signal level LVSL1 of the first signal SL1 changes in accordance with a signal level LVSL2 of the second signal SL2. Then, the processor 100 in the shoulder-mounted speaker 10g outputs the first signal SL1, the signal level LVSL1 of which has changed in accordance with the signal level LVSL2 of the second signal SL2, to the vibrator 101.

A more detailed description follows. As shown in FIG. 10A, if the signal level LVSL2 of the second signal SL2 does not change, the signal level LVSL1 of the first signal SL1 does not change (between t0 and t1, between t2 and t3, and after t4 in FIG. 10A). As shown in FIG. 10A, if the signal level LVSL2 of the second signal SL2 increases, the signal level LVSL1 of the first signal SL1 increases in accordance with the increase of the signal level LVSL2 (between t1 and t2 in FIG. 10A). That is, the vibration of the vibrator 101 increases in proportion to the increase in magnitude of the sound emitted from the speaker 102 (hereinafter referred to as a proportional increase). On the other hand, as shown in FIG. 10A, if the signal level LVSL2 of the second signal SL2 decreases, the signal level LVSL1 of the first signal SL1 also decreases (between t3 and t4 in FIG. 10A). In this case, the vibration of the vibrator 101 decreases in accordance with the decrease in magnitude of the sound emitted from the speaker 102 (hereinafter referred to as a proportional decrease). In particular, the shoulder-mounted speaker 10g is configured in the same manner as the shoulder-mounted speaker 10, except that the processor 100 changes the signal level LVSL1 of the first signal SL1 in accordance with the signal level LVSL2 of the second signal SL2. Thus, with the shoulder-mounted speaker 10g, the processor 100 increases the signal level LVSL1 of the first signal SL1 in accordance with the increase of the signal level LVSL2 of the second signal SL2, and decreases the signal level LVSL1 of the first signal SL1 in accordance with the decrease of the signal level LVSL2 of the second signal SL2, as seen in FIG. 10A.

The method of changing signal level LVSL1 of the first signal SL1 corresponding to the signal level LVSL2 of the second signal SL2 is not limited to the examples of the proportional increase and the proportional decrease. The method of change of the signal level can be changed within the scope of the invention. For example, as shown in FIG. 10B, the signal level LVSL1 of the first signal SL1 can be increased to a predetermined maximum value (or decreased to a predetermined minimum value) of the change width, which is triggered by the instant that the signal level of the second signal SL2 changes. In particular, the shoulder-mounted speaker 10g is configured in the same manner as the shoulder-mounted speaker 10, except that the processor 100 changes the signal level LVSL1 of the first signal SL1 in accordance with the signal level LVSL2 of the second signal SL2. When the processor 100 detects an increase or rising edge in the signal level LVSL2 of the second signal SL2, the processor 100 increases the signal level LVSL1 of the first signal SL1 to the maximum value. Also, when the processor 100 detects a decrease or falling edge in the signal level LVSL2 of the second signal SL2, the processor 100 decreases the signal level LVSL1 of the first signal SL1 to the minimum value.

As shown in FIG. 10B, it is not necessary for the amount of change of the signal level LVSL1 to be the same as the amount of change of the signal level LVSL2. For example, the amount of change of the signal level LVSL1 can be smaller than the amount of change of the signal level LVSL2. Similarly, the amount of change of the signal level LVSL1 can be greater than the amount of change of the signal level LVSL2.

### Effect of Seventh Embodiment

By means of the shoulder-mounted speaker 10g, the user can have an enhanced sense of presence. More specifically, the signal level LVSL1 of the first signal SL1 changes in accordance with the signal level LVSL2 of the second signal SL2. In this case, the vibrations of the vibrator 101 change in accordance with the change in magnitude of the sound emitted from the speaker 102. That is, the shoulder-mounted speaker 10g vibrates in accordance with the sound intensity. The user's sense of presence can then be enhanced by the vibrations corresponding to the sound intensity. For example, if the sound of an exploding bomb is reproduced from the speaker 102 of the shoulder-mounted speaker 10g, the vibrator 101 of the shoulder-mounted speaker 10g generates a vibration with a magnitude that corresponds to the sound of the explosion. The user then recognizes the vibration with the large magnitude generated by the shoulder-mounted speaker 10g. Thus, the shoulder-mounted speaker 10g can provide the user with a sense of presence, as if the user were experiencing the sound of an explosion. In this manner, the shoulder-mounted speaker 10g can enhance the user's sense of presence.

### Eighth Embodiment

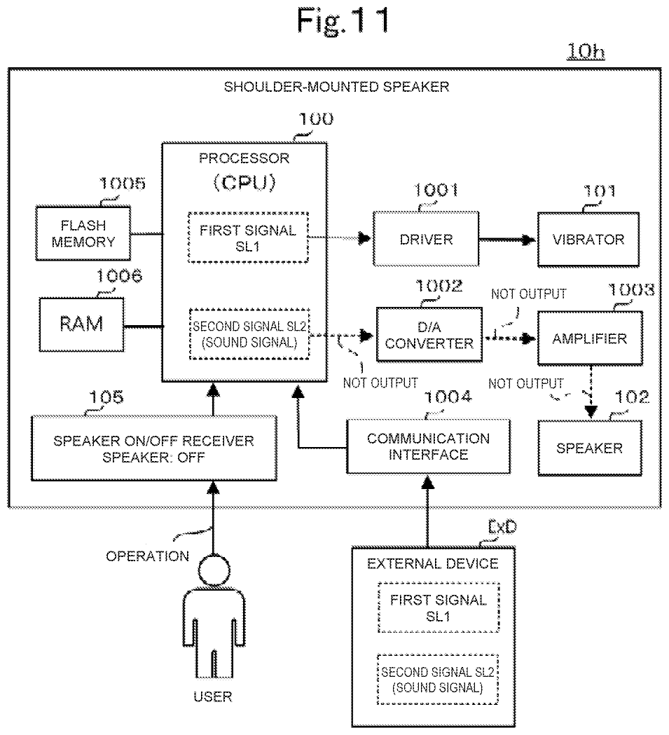

A shoulder-mounted speaker 10h according to an eighth embodiment will be described below with reference to the drawings. FIG. 11 is a block diagram illustrating the configuration of the shoulder-mounted speaker 10h according to the eighth embodiment.

The shoulder-mounted speaker 10h is basically the same as the shoulder-mounted speaker 10, but differs from the shoulder-mounted speaker 10 in that a speaker on/off receiver (speaker on/off reception unit) 105 is provided. The shoulder-mounted speaker 10h receives an operation from the user to turn the reproduction of sound from the speaker 102 on or off, in accordance with the content of an operation input to the speaker on/off receiver 105.

A more detailed description follows. If the speaker on/off receiver 105 receives a speaker off operation from the user, the speaker on/off receiver 105 commands the processor 100 to stop the output of the second signal SL2 to the D/A converter 1002, as seen in FIG. 11. As a result, the second signal SL2 is not output to the amplifier 1003. Therefore, the second signal SL2 is not output to the speaker 102. As a result, the speaker 102 changes from a state in which sound is being emitted to a state in which sound is not being emitted. On the other hand, if the speaker on/off receiver 105 receives a speaker on operation from the user, the speaker on/off receiver 105 commands the processor 100 to output the second signal SL2 to the amplifier 1003. As a result, the speaker 101 changes from a state in which sound is not being emitted to a state in which sound is being emitted.

The speaker on/off receiver 105 is, for example, an electronic device such as a touch panel, an on/off switch, or the like. In other words, the speaker on/off receiver 105 can be composed of any device that can receive an operation from the user.

### Effect of Eighth Embodiment

By means of the shoulder-mounted speaker 10h, the shoulder-mounted speaker 10h can play or stop the sound in accordance with the user's intentions. More specifically, the shoulder-mounted speaker 10h includes the speaker on/off receiver 105 that receives an operation to turn the speaker 102 on or off. As a result, when the user wishes to recognize only the vibrations generated by the vibrator 101, the user can stop the generation of sound by turning the speaker on/off receiver 105 off. On the other hand, if the user wishes to recognize both vibration and sound, sound and vibration can be generated by turning the speaker on/off receiver 105 on. Then, by means of the speaker on/off receiver 105, for example, the user is able to switch between generating only vibration and generating both vibration and sound during the performance. Therefore, the shoulder-mounted speaker 10h can be controlled so as to play or stop the sound in accordance with the user's musical scenario.

### MODIFICATION EXAMPLES

The shoulder-mounted speaker according to the present invention is not limited to the shoulder-mounted speakers 10, 10a, 10b, 10b2, 10d, 10d2, 10e, 10f, 10g, 10h according to the embodiments described above, and can be modified within the scope of the invention.

The first signals SL1, SL1b, SL1d, SL1f, which are drive signals for controlling the motor, and the like, can be generated in the shoulder-mounted speakers 10, 10a, 10b, 10b2, 10d, 10d2, 10e, 10f, 10g, 10h. For example, a sampling program is stored in the flash memory 1005 of the shoulder-mounted speaker 10. The shoulder-mounted speakers 10, 10a, 10b, 10b2, 10d, 10d2, 10e, 10f, 10g, 10h store data of a musical piece in advance. The shoulder-mounted speakers 10, 10a, 10b, 10b2, 10d, 10d2, 10e, 10f, 10g, 10h then use the sampling program to sample the sound of the stored musical piece data at a prescribed sampling rate. The shoulder-mounted speakers 10, 10a, 10b, 10b2, 10d, 10d2, 10e, 10f, 10g, 10h use digital signals obtained as a result of sampling as the first signals SL1, SL1b, SL1d, SL1f. The second signal SL2, which is a sound signal, can be generated in the shoulder-mounted speakers 10, 10a, 10b, 10b2, 10d, 10d2, 10e, 10f, 10g, 10h, in the same manner as the first signals SL1, SL1b, SL1d, SL1f.

It is not necessary for the right vibrator 101R to be located at the distal end portion STR of the shoulder-mounted speaker 10a in the shoulder-mounted speaker 10a. The right vibrator 101R can be located anywhere in the right portion 10R. For example, the right vibrator 101R can be located at the center (or the vicinity thereof) of the right portion 10R.

It is not necessary for the left vibrator 101L to be located at the distal end portion STL of the shoulder-mounted speaker 10a in the shoulder-mounted speaker 10a. The left vibrator 101L can be located anywhere in the left portion 101L. The left vibrator 101L can be located at the center (or the vicinity thereof) of the left portion 10L.

It is not necessary for the speaker 102 to include the right speaker 102R and the left speaker 102L. The speaker 102 can comprise only one of the right speaker 102R or the left speaker 102L.

The number of speakers provided in the shoulder-mounted speaker 10 is not limited to two. Specifically, the number of speakers provided in the shoulder-mounted speaker 10 can be one. Alternatively, the number of speakers provided in the shoulder-mounted speaker 10 can be three or more.

The speaker 102 can be located in the rear portion 10T.

Two or more speakers can be located in the right portion 10R. Two or more speakers can be located in the left portion 10L.

Two or more vibrators 101 can be located in the rear portion 10T. Two or more vibrators 101 can be located in the right portion 10R. Two or more vibrators 101 can be located in the left portion 10L.

As shown in FIG. 3, the mixer 20 can be connected to an external device 30 different from the shoulder-mounted speaker 10 via the communication interface 200.

It is not necessary for the first signal SL1 to be a signal obtained by filtering the high-frequency region of the sound signal.

It is not necessary for the first signal SL1 to be a signal calculated from the sound signal and a signal that drives the vibrator at a prescribed drive cycle.

It is not necessary for the first signal SL1 to be a signal corresponding to a BPM value calculated from the sound signal.

It is not necessary for the shoulder-mounted speaker 10 to comprise the vibrator on/off receiver 103.

It is not necessary for the shoulder-mounted speaker 10 to comprise the vibration controller 104.

It is not necessary for the vibration parameter to include a BPM value. It is not necessary for the vibration parameter to include the vibration magnitude. It is not necessary for the vibration parameter to include the length of one vibration.

It is not necessary for the first signal SU to change in accordance with the signal level LVSL2 of the second signal SL2.

It is not necessary for the vibrator 101 to be a pendulum-type motor or a transducer.

It is not necessary for the shoulder-mounted speaker 10 to comprise the speaker on/off receiver 105.

It is not necessary for the shoulder-mounted speaker 10 to be U-shaped in plan view.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a shoulder-mounted speaker on the shoulders of a user. Accordingly, these directional terms, as utilized to describe the shoulder-mounted speaker should be interpreted relative to a user in an upright position on a horizontal surface. The terms “left” and “right” are used to indicate the “right” when referencing from the right side as viewed from the rear of the user, and the “left” when referencing from the left side as viewed from the rear of the user.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. it is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A shoulder-mounted speaker comprising:
a processor configured to acquire a first signal and a second signal that is a sound signal;
a vibrator configured to vibrate based on the first signal input from the processor; and
a speaker configured to emit sound based on the second signal input from the processor.

2. The shoulder-mounted speaker according to claim 1, further comprising
a housing including a rear portion that is configured to be located behind a user's neck, a right portion that is configured to be located to a right of the user and that is bent forward from a right end of the rear portion, and a left portion that is configured to be located to a left of the user and that is bent forward from a left end of the rear portion.

3. The shoulder-mounted speaker according to claim 1, wherein
the first signal is a signal obtained by filtering a high-frequency region of the sound signal.

4. The shoulder-mounted speaker according to claim 1, wherein
the first signal is a signal calculated from the sound signal to drive the vibrator at a prescribed drive cycle.

5. The shoulder-mounted speaker according to claim 1, wherein
the vibrator is configured to vibrate in accordance with a BPM value calculated from a periodic signal.

6. The shoulder-mounted speaker according to claim 1, further comprising
a vibrator on/off receiver configured to receive an operation to turn a vibration of the vibrator on or off.

7. The shoulder-mounted speaker according to claim 1, further comprising
a vibration controller configured to receive a vibration parameter for controlling the vibration of the vibrator, and
the vibration of the vibrator being controlled based on the vibration parameter.

8. The shoulder-mounted speaker according to claim 7, wherein
the vibration parameter includes at least a BPM value.

9. The shoulder-mounted speaker according to claim 7, wherein
the vibration parameter includes at least a magnitude of the vibration of the vibrator.

10. The shoulder-mounted speaker according to claim 1, wherein
a signal level of the first signal changes in accordance with a signal level of the second signal.

11. The shoulder-mounted speaker according to claim 1, wherein
the vibrator includes a vibration motor or a transducer.

12. The shoulder-mounted speaker according to claim 1, further comprising
a speaker on/off receiver that receives an operation to turn the speaker on or off.

13. The shoulder-mounted speaker according to claim 1, wherein
the first signal is indicative of at least one of a prescribed frequency of a vibration of the vibrator and a prescribed drive cycle of the vibrator.

14. The shoulder-mounted speaker according to claim 2, wherein
the vibrator is disposed within the rear portion of the housing.

15. The shoulder-mounted speaker according to claim 2, wherein
the vibrator includes left and right vibrators that are disposed within the right portion and the left portion of the housing, respectively.

16. The shoulder-mounted speaker according to claim 2, wherein
the speaker is disposed within the housing.

17. The shoulder-mounted speaker according to claim 2, wherein
the speaker includes right and left speakers that are disposed within the right portion and the left portion of the housing, respectively.

18. The shoulder-mounted speaker according to claim 16, wherein
the right and left speakers are configured to emit sound based on right and left channels of the sound signal, respectively.

19. The shoulder-mounted speaker according to claim 2, wherein
the housing is symmetrical with respect to a center line of the shoulder-mounted speaker that extends across the rear portion of the housing.

20. The shoulder-mounted speaker according to claim 19, wherein
the speaker is asymmetrically arranged relative to the vibrator with respect to the center line of the shoulder-mounted speaker.
